(19) United States
(12) Patent Application Publication
(10) Pub. No.: US 2016/0107097 A1
(43) Pub. Date: Apr. 21, 2016

(54) Distallation System with Heat Recovery

(71) Applicant: George Atwell, St. Norbert (CA)

(72) Inventor: George Atwell, St. Norbert (CA)

(21) Appl. No.: 14/518,630

(22) Filed: Oct. 20, 2014

(51) Int. Cl. B01D 3/00; C02F 1/06; B01D 3/10

(52) U.S. Cl. CPC B01D 3/007; B01D 3/106; C02F 1/06; C02F 2201/002; C02F 2303/10

(57) ABSTRACT

A distillation system is provided having an evaporation conduit and a condensing conduit connected by a transfer system for transferring distillate vapour from the evaporation conduit to the condensing conduit to condense the distillate. The evaporation and condensing conduits operate under vacuum pressure. A distillate conduit communicates with the condensing conduit for dispensing condensed distillate therefrom. An air passage in heat exchanging relationship with the distillate conduit produces an upward heated flow which is directed to a turbine to extract usable energy therefrom. The transfer system comprise a rotor having port therein which extend from the evaporation conduit to the condensing conduit with

### FIELD OF THE INVENTION

The present invention relates to a distillation system for separating a distillate from a solution and more particularly to a distillation system including a heat recovery system for recovery of heat from the produced distillate.

### BACKGROUND

One known example of a distillation system involves freshwater being separated from salt water as a distillate. Due to receding freshwater resources, the development of desalination systems are important for the production of usable water from saltwater for consumption and agriculture for example. Examples of desalination systems are found in the following U.S. Pat. No. 5,932,074 to Hoiss; U.S. Pat. No. 4,770,748 to Cellini et al; U.S. Pat. No. 4,302,297 to Humiston; U.S. Pat. No. 4,110,174 to Carson; U.S. Pat. No. 4,078,976 to Spears; U.S. Pat. No. 4,536,257 to Atwell and U.S. Pat. No. 7,041,198 also to Atwell. In order to operate in the most efficient manner, it is desirable to transfer vapor from the evaporating chamber to the condensing chamber of the system with minimal backflow from the condensing chamber to the evaporating chamber, while using a simple mechanism contrary to prior art methods.

Furthermore, as described in U.S. Pat. No. 7,041,198 to Atwell, the low pressure vapor produced at the evaporation side of a vacuum distillation system draws considerable heat energy from the source solution and the surrounding atmosphere such that condensation of the distillate on the corresponding condensing side of the distillation systems tends to result in a very high temperature distillate as compared to the source solution and the surrounding atmosphere. The prior art system for capturing heat however is limited to capturing heat which is radiated from the distillate column.

### SUMMARY OF THE INVENTION

According to one aspect of the invention there is provided a distillation system comprising:

an evaporation conduit;

an intake supply conduit in communication between a source of solution and the evaporation conduit at the top end of the intake supply conduit;

an intake return conduit in communication between the evaporation conduit at a top end of the intake return conduit and a return sump;

a condensing conduit;

a transfer system connecting the evaporation conduit and the condensing conduit and which is arranged to transfer distillate vapor from the evaporation conduit to the condensing conduit to condense the distillate vapor in the condensing conduit;

a distillate conduit in communication with the condensing conduit so as to be arranged to collect condensed distillate therein;

a vacuum pump connected to at least one of the evaporation conduit and the condensing conduit so as to be arranged to evacuate air from the evaporation and condensing conduits;

a heat exchanger passage in heat exchanging relationship with the distillate conduit so as to be arranged to produce a heated flow of fluid therein; and

a turbine in communication with the heat exchanger passage so as to be arranged to extract usable power from the heated flow of fluid in the heat exchanger passage.

The use of a passage in heat exchanging relationship with the distillate conduit provides a direct and efficient means of extracting heat to an auxiliary fluid, such as air, such that a turbine can then be used in turn to convert the energy into other usable forms.

Preferably the heat exchanger passage comprises an upright passage arranged to direct the heated flow of fluid upwardly therethrough.

The distillate conduit preferably extends downwardly from the condensing conduit such that the distillate conduit and the heat exchanger passage are arranged in a counter-flow configuration relative to one another.

The heat exchanger passage and the distillate conduit are preferably in a direct heat exchanging relationship with one another.

Preferably the heat exchanger passage fully surrounds the distillate conduit.

The distillation system may further comprise a uniform body of heat exchanging material in which the distillate conduit comprises at least one distillate passage extending longitudinally through the uniform body and in which the heat exchanger passage is in heat exchanging relationship with the uniform body.

Preferably the heat exchanger passage surrounds the uniform body along a full length of said at least one distillate passage through the uniform body.

The at least one distillate passage preferably comprises a plurality of distillate passages extending longitudinally through the uniform body in a parallel and spaced apart relationship relative to one another.

The heat exchanging material of the uniform body may comprise aluminum.

A grid of aluminum may also be supported in the condensing conduit at a head of the distillate conduit upon which the distillate is arranged to be condensed.

Preferably a bottom wall of at least the condensing conduit is slope downwardly in a flow direction from the transfer system to the distillate conduit.

The distillation system may be used in combination with a greenhouse, in which the turbine is arranged to be exhausted into the greenhouse.

The transfer system may comprise a pump rotor having a first side in communication with the evaporation conduit, a second side in communication with the condensing conduit, and at least one port communicating between an inlet opening at the first side and an outlet opening at the second side. In this instance the pump rotor is preferably supported for rotation about a central axis with said at least one port being oriented with increasing radial distance from the central axis from the inlet opening to the outlet opening so as to be arranged to transfer fluid from the first side to the second side under centrifugal force when rotated.

According to a second aspect of the present invention there is provided a distillation system comprising:

an evaporation conduit;

an intake supply conduit in communication between a source of solution and the evaporation conduit at the top end of the intake supply conduit;

an intake return conduit in communication between the evaporation conduit at a top end of the intake return conduit and a return sump;

a condensing conduit;

a transfer system connecting the evaporation conduit and the condensing conduit and which is arranged to transfer distillate vapor from the evaporation conduit to the condensing conduit to condense the distillate vapor in the condensing conduit;

a distillate conduit in communication with the condensing conduit so as to be arranged to collect condensed distillate therein; and

a vacuum pump connected to at least one of the evaporation conduit and the condensing conduit so as to be arranged to evacuate air from the evaporation and condensing conduits;

the transfer system further comprising a pump rotor having a first side in communication with the evaporation conduit, a second side in communication with the condensing conduit, and at least one port communicating between an inlet opening at the first side and an outlet opening at the second side;

the pump rotor being supported for rotation about a central axis; and

said at least one port being oriented with increasing radial distance from the central axis from the inlet opening to the outlet opening so as to be arranged to transfer fluid from the first side to the second side under centrifugal force when rotated.

The ports of the pump are thus arranged to provide a continuously pumped flow of vapor from the evaporation conduit to the condensing conduit with no backflow therethrough. The design of the pump using a single rotor as the only moving element is also very reliable and easy to maintain.

Preferably there is provided a plurality of ports at circumferentially spaced apart locations about the central axis of the rotor.

Preferably the distillation system further comprising a transfer tube rotatably supporting the pump rotor therein such that the central axis of the pump rotor is substantially concentric with the transfer tube and such that the transfer tube defines at least a portion of the evaporation conduit and at least a portion of the condensing conduit on opposing sides of the pump rotor.

The transfer system may further comprise an electric motor having a stator portion supported about the transfer tube and a rotor portion integrally supported on the pump rotor for rotation therewith relative to the transfer tube.

One embodiment of the invention will now be described in conjunction with the accompanying drawings in which:

### BRIEF DESCRIPTION OF THE DRAWINGS

FIG. 1 is a schematic representation of the distillation system;

FIG. 2 is a vertical cross section of the distillate conduit and surrounding heat exchanger passage of the distillation system according to FIG. 1;

FIG. 3 is a sectional view of the distillate conduit and the surrounding heat exchanger passage along the line 3-3 of FIG. 2;

FIG. 4 is a vertical cross section of the transfer pump of the distillation system according to FIG. 1;

FIG. 5 is an end view of the second side of the transfer pump rotor along the line 5-5 of FIG. 4; and

FIG. 6 is an end view of the first side of the transfer pump rotor along the line 5-5 of FIG. 4.

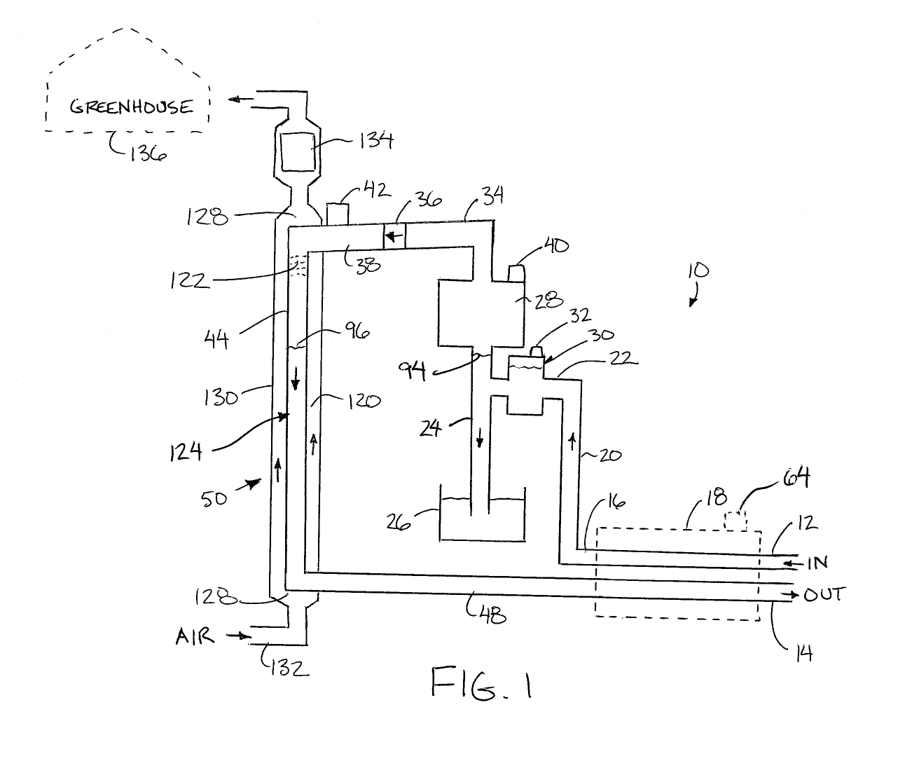

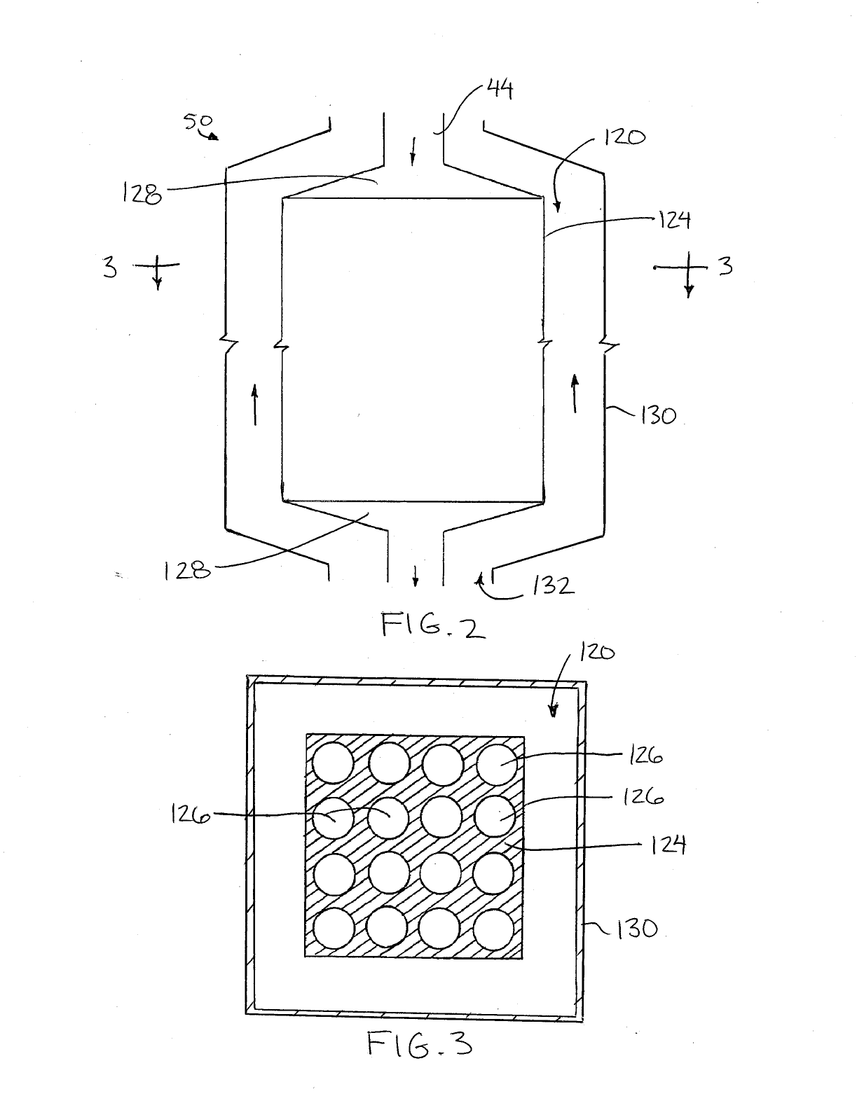

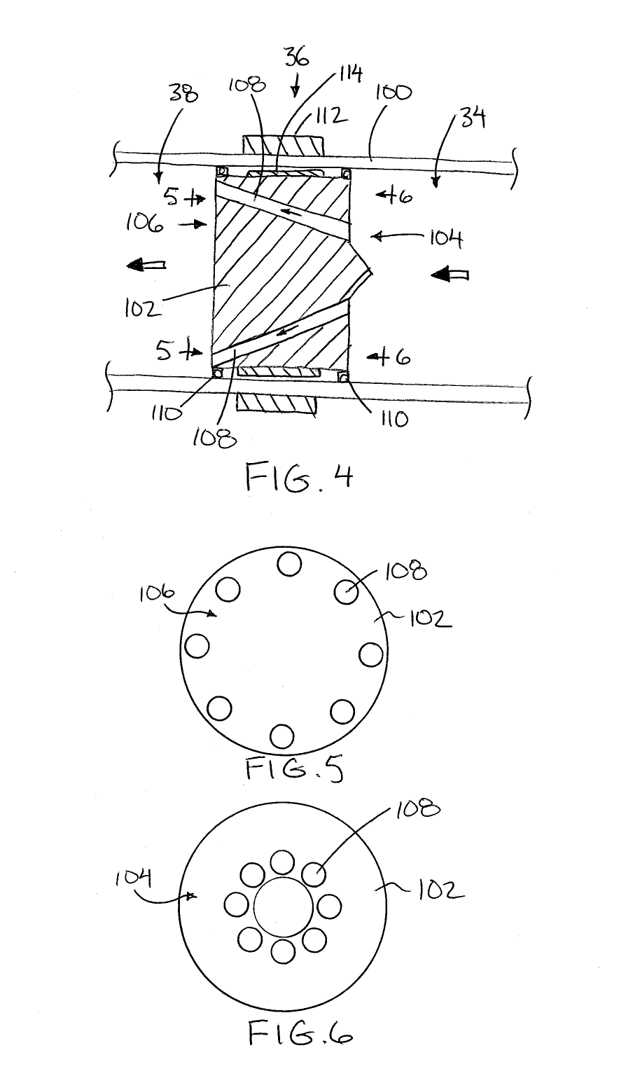

In the drawings like characters of reference indicate corresponding parts in the different figures.

### DETAILED DESCRIPTION

Referring to the accompanying drawings, there is illustrated a distillation system generally indicated by reference numeral 10. The system is particularly useful for desalinating sea water or some other suitable solution source 12 for producing fresh water or some other distillate at a distillate outlet 14 of the system. In alternative arrangements, the system may be used to concentrate a solution by disposing of removed distillate. The system is also arranged to produce heat for useable power.

Solution is drawn into the system from the source 12 through a suitable inlet conduit 16 which extends generally horizontally through a heat exchanger 18 before communication with the base of an intake supply conduit 20. The intake supply conduit 20 is an upright column which includes a horizontal portion 22 at a top end thereof which connects the intake supply conduit 20 to an intake return conduit 24. The intake return conduit 24 similarly comprises an upright column for containing fluid therein which is open at a bottom end for communication with a return sump 26 at atmospheric pressure and which is in unrestricted communication at a top end with an evaporation chamber 28.

The horizontal portion 22 of the intake supply conduit 20 is connected between the top end of the upright column of the intake supply conduit and the upright column of the intake return conduit adjacent the top end thereof spaced slightly below the unrestricted open top end of the intake return conduit. A de-aerator 30 is coupled in series with the horizontal portion 22 of the intake supply conduit 20 for removing gas dissolved within fluid passing through the intake supply conduit. The de-aerator 30 generally comprises an enlarged chamber extending upwardly beyond a periphery of the intake supply conduit. The chamber of the de-aerator is sealed with respect to the intake supply conduit and permits a vacuum to be maintained therein so that gas dissolved within the fluid in the intake supply conduit is drawn into a vacuum space located in an upper portion of the chamber of the de-aerator. A suitable vacuum pump 32 is provided in communication with a top end of the chamber of the de-aerator for maintaining suitable vacuum pressures within the de-aerator.

The open unrestricted top end of the intake return conduit 24 communicates with the evaporation chamber 28 which is considerably enlarged in cross sectional area as compared to the intake return conduit for slowing the passage of fluid therethrough. An evaporation conduit 34 is coupled to a top end of the evaporation chamber 28 and extends generally horizontally to a transfer pump 36 coupled at an inlet to the evaporation conduit 34 and at an outlet to a condensing conduit 38 which similarly extends substantially horizontally. A vacuum pump 40 communicates with the evaporation chamber to maintain a desirable vacuum pressure within the evaporation chamber and evaporation conduit. The enlarged cross sectional area of the evaporation chamber is useful for ensuring that minimal fluid droplets are carried up into the evaporation conduit by rising vapours from the unrestricted top end of the intake return conduit.

The condensing conduit 38 includes a vacuum pump 42 in communication therewith for maintaining a desired vacuum pressure therein. The condensing conduit 38 communicates with a distillate conduit 44 in the form of an upright column in which distillate condenses from the condensing conduit 38 at a top end thereof. A base of the distillate conduit 44 is in open communication with a horizontal outlet conduit 48 which passes through the heat exchanger 18 for exchanging heat with the inlet conduit 16. The outlet conduit 48 terminates at the distillate outlet 14 of the system.

A heat capturing system 50 is provided for capturing heat released from the distillate conduit 44 as described in further detail below.

Operation of the distillation system begins by first adjusting the fluid levels in the return sump 26 to cover the base of the intake return conduit 24, in the distillate sump 46 to cover the base of the distillate conduit 44 and at the source 12 to enclose the base of the intake supply conduit 20. The vacuum pumps 40 and 42 at the evaporation conduit and condensation conduit respectively are operated to empty the closed system of atmosphere. This causes the fluid level in the intake return conduit 24 to rise in the order of thirty-two feet to the level indicated at 94 which is positioned above a point of communication with the intake supply conduit 20 but below the unrestricted open communication at the top end with the evaporation chamber 28. Accordingly water level in the distillate conduit 44 rises to level 96 which is slightly higher than the level 94 in the intake return conduit. Meanwhile the intake supply conduit 20 is substantially filled with water which rises up to the point of communication of the intake supply conduit with the intake return conduit and beyond.

The transfer pump 36 is operated at an initially slow speed. The vacuum pump 64 on the heat exchanger 18 is arranged to operate automatically in response to variations in pressure in the chamber 60 so as to maintain the atmospheric pressure in the chamber at approximately 13 pounds per square inch (psi) to allow some entrained air to be removed from the intake fluid passing through the heat exchanger along the inlet conduit 16.

The vacuum pump 32 of the de-aerator 30 is also arranged to operate automatically in response to atmospheric pressure within the de-aerator chamber to keep atmospheric pressure at approximately 0.5 psi. Further downstream the pump 40 on the evaporation chamber 28 is operated to maintain pressure in the order of 0.46 psi which is slightly below pressure within the de-aerator 30. The vacuum pump 42 in communication with the condensing conduit is similarly operated to maintain atmospheric pressure at approximately 0.46 psi to be equal with pressure within the evaporation conduit. Continued operation of the transfer pump 36 will pump distillate vapour from the evaporation conduit to the condensing conduit to cause condensation due to excess vapour pressure in the condensing conduit at which point the condensing distillate forming in the distillate conduit 44 produces a continuous flow of distillate which exits the distillate sump 46 through the outlet conduit 48. Heat from the distillate in the outlet conduit passes through respective outlet tubes 62 in the heat exchanger for preheating the source of solution at a point before the solution rises up into the intake supply conduit 20 beyond a surface level of the source of solution.

Considerable heat is produced at the distillate conduit 44 as the distillate vapour condenses for capture by the heat capturing system 50.

In operation, as the distillate evaporates at the open outlet of the intake return conduit 24, the solution becomes denser and more concentrated and begins to flow downwardly into the return sump 26. Vacuum pressure in the evaporation chamber thus continually draws more solution in through the intake supply conduit 20 to maintain the level substantially at the level indicated 94. The cross sectional area of the evaporation chamber 28 being substantially larger than the cross sectional area of the intake supply or intake return conduits leading to it, greatly reduces the flow rate of the vapour through the evaporation chamber to the evaporation conduit and thus allows droplets of solution or distillate carried by the vapour sufficient time to either evaporate within the evaporation chamber or fall back down into the intake return conduit.

The use of the heat exchanger 18 to raise the temperature of the inlet water, reduces the quantity of intake feed water needed. This enables the process of water purification to be carried on with a wide range of intake water temperatures, but the lower the intake water temperature, the larger will the heat exchanger need to be to allow greater time for heat exchange and the less heat will be available to be siphoned off for work by the heat capturing system 50. In the alternative, when it is desirable to capture more energy with the heat capturing system 50, the heat exchanger may be used minimally or not at all if substantially all of the heat is already extracted from the distillate.

System 10 further includes a transfer tube 100 in the form of an elongate cylindrical passage which spans near horizontally and which defines a portion of the evaporator conduit 34 and the condensing conduit 38. The transfer pump 36 includes a pump rotor which is rotatable about a central axis concentric within the transfer tube 100. The pump rotor 102 includes a generally cylindrical rotor body which extends axially between a first side 104 in open communication with the evaporator conduit 34 and a second side 106 in open communication with the condensing conduit 38. The evaporator conduit is thus defined as the portion of the transfer tube 100 at the first side of the rotor body while the condensing conduit is defined as the portion of the transfer tube at the second side of the rotor body. The transfer tube 100 is situated such that the bottom wall of the tube is sloped gradually and continually from a first end where the evaporator conduit communicates with the evaporator chamber to an opposing second end where the condensing conduit communicates with the distillate conduit.

The pump rotor includes a plurality of ports 108 formed therein at evenly circumferentially spaced positions about the central axis of the rotor. Each port communicates from an inlet opening at the first side 104 to an outlet opening at the second side 106. Each port is generally linear from the inlet opening to the outlet opening at an inclination so as to increase in radial distance from the central axis from the first side to the second side of the rotor. The cross sectional flow area through the ports remains constant from the inlet openings to the outlet openings. The ports 108 serve as the only communication from the evaporation chamber to the condensing chamber.

In use, the rotor is rotated about its central axis such that centrifugal forces act on the vapor within the ports to drive a continuous flow of vapor from the evaporation conduit to the condensing conduit with no interruptions or backflow of the vapor in the reverse direction.

The rotor is supported relative to the transfer tube by annular bearings 110 about the circumference of the rotor body to rotatably support the perimeter of the rotor body relative to the inner wall of the transfer tube 100.

Rotation of the pump rotor is driven by an electric motor including a stator portion 112 and a rotor portion 114. The rotor portion comprises permanent magnets which are integrally supported about the circumference of the rotor body within the interior of the transfer tube. The stator portion comprises an electromagnetic coil supported circumferentially about the exterior of the transfer tube 100 such that supplying electrical power to the electromagnetic coil induces rotation of the rotor portion and the corresponding rotor body upon which it is mounted.

The heat capturing system 50 in the illustrated embodiment defines a heat exchanger passage 120 in heat exchanging relationship with the distillate conduit as described in the following. An aluminum condensing grid 122 is provided in the form of an open mesh with through openings therein and which spans across the head of the distillate conduit in direct communication with the evaporation conduit to encourage condensing of vapor thereon as the vapor passes through the openings in the aluminum grids.

The heat capture system further includes a uniform body 124 of aluminum in direct conductive contact with the aluminum grid 122. The body 124 includes a plurality of distillate passages 126 formed therein which collectively define the distillate conduit. The heat exchanger body 124 is elongate in a vertical direction and defines the distillate passages extending vertically and longitudinally therethrough as a plurality of thru bores which are parallel and spaced apart from one another. The distillate passages 126 openly communicate with one another at a manifold space 128 at opposing top and bottom ends of the heat exchanger body 124. The aluminum condensing grid 122 is provided within the manifold space above the uniform body 124.

An insulated jacket 130 is provided about the heat exchanger body 124 to span vertically along the full length thereof. The jacket 130 is spaced radially outward from the body 124 so as to define the heat exchanger passage 120 as an annular passage fully surrounding the body 124 defining the distillate conduit therein along the full length of the distillate passages 126. The uniform body 124 thus defines a single wall of uniform material in direct heat exchanging relationship by conduction between the distillate within the distillate passages 126 and a corresponding fluid within the heat exchanger passage 120 defined between the body 124 and the surrounding jacket 130.

The heat exchanger passage is a substantially vertical passage from a bottom end in communication with an air inlet 132 to a top end in communication with the inlet of a turbine 134. Air is introduced into the passage 120 through the communication with the inlet 132 at the bottom end. As the air is heated within the heat exchanger passage by heat exchanging relationship with the distillate within the body 124, the expansion of the heated air drives an upward flow of the air within the heat exchanging passage in a counter-flow arrangement with the downward flow of distillate through the central distillate conduit. The upward heated airflow is directly fed into the inlet of the turbine which is driven to rotate by the upward flow to extract usable power from the flow to produce mechanical work or to drive a generator for storing electrical power for example. Any heat remaining within the distillate as the distillate exits the bottom of the uniform body can be directed through the outlet conduit 48 for heat exchanging relationship with the inlet conduit 116 at the heat exchanger 18 as described above.

Any heat remaining within the upward airflow directed to the turbine subsequent to extraction of energy by the turbine can be exhausted directly to a greenhouse 136.

Turning now to an exemplary operation of the system 10, consider producing 1000 gallons of pure water in one minute. There is 16 g of water in 1 cubic meter of mist at 22 degrees Celsius (72 degrees Fahrenheit). For example 16/450 pounds of water in (39/36) (39/36) (39/36) cubic yards of mist=0.03556 pounds of water in 1.2714 cubic yard of mist. Accordingly, 0.03556/1.2714 pounds of water in 1 cubic yard of mist=0.02797 pounds of water in 1 cubic yard of mist=0.02797/27 pounds in 1 cubic foot of mist=0.00104 pounds of water in 1 cubic foot of mist. This gives 1 pound of water in 961,538 cubic feet of mist or 60,000 cubic feet mist to 1 cubic foot of water.

To produce 1,000 gallons of pure water in one minute the blower must do work as follows: 1000 gallons=10,000 pounds water (10,000/62.4) cubic feet of water as vapour from the salt water vapour side to the fresh water vapour side. (10,000/62.4) (60,000 VAP/33,000 btu) (0.38 psi) (144 square inches) (0.746 kw)=11894.27 kw (at 22 degrees Celsius).

In order to boil off that 1000 gallons (10,000 pounds) in one minute, the sea will have to put in energy as follows: 1000 gallons (10 pounds) (1000 btu) (778 foot pounds)/33,000 foot pounds per minute=235,758 hp (0.746)=175,875 kw.

Thus the ratio of Blower Energy Input to Sea Energy Input is 11.894 kW to 175,875 kW, otherwise stated as 1 to 14.8.

The heat that arrives at the distillate pipe is considered as follows. In the first 6 seconds of producing that 1000 gallons, that is in 1/10 of a minute, 100 gallons will be produced=1000 pounds. But the sea will have contributed 1000 btu to evaporate each pound for a total of 1,000,000 btu, which is enough to raise that 1000 pounds of water to 1000 degrees Fahrenheit, a very significant order of power. But this heat arrives not suddenly, but by increments.

Now if an insulated jacket of ambient air is allowed to pass up the distillate leg, that high heat if delivered as it arrives, will force a rapid rush of hot air up the outside of the distillate to drive the turbine and exhaust non-toxic air to a mammoth greenhouse.

The construction of the distillate leg will now be further discussed. Consider using aluminum pipes of 4 inches in diameter and ⅛ inch thick. The average distance of the water in the pipe from the skin of the pipes is 1 inch.

Note: water transmits heat at 4 btu per minute per square foot, per 1 degree Fahrenheit of difference between itself and its surrounding. This is slowly. Aluminum transmits heat at 1600 btu per 1 degree Fahrenheit difference between itself and its environment, per square foot. This is fast, and a difference of 50 degrees Fahrenheit with the surroundings, significantly multiplies that speed. A distillate leg, or a series of such legs, so constructed and so surrounded by up-flows of effluent air would enable heat to be usefully removed as it arrives and thus allows the process to proceed.

The dissipation of the heat formed at the distillate head will now be considered. The vapour is blown into an aluminum grid at the head of distillate column, so that the vapour molecules would condense in the presence of aluminum. All of the aluminum would be connected and head to the aluminum skin of the column, which in turn would be jacketed by the upflowing jacket of ambient air (for example 80 degrees Fahrenheit has a heat sink for the 1000 degrees Fahrenheit that is at the column head after 6 seconds, that is 1/10 per minute of operation).

Considering aluminum conducts heat at 1600 btu per minutes, per square foot, per minute of what it touches (for example: 160 btu in 6 seconds as the heat arrives). But being 900 degrees hotter than ambient air, it conducts heat 900 times faster=160×900=162,000 btu per minute=16,200 btu in 6 seconds or 1/10 of a minute. Accordingly this aluminum can remove the heat arriving at the distillate column faster than it would arrive causing the jacket of ambient air to gush up, in a fierce jet, through a turbine to do work.

Some additional considerations are noted in the following:

The slope of the vapour passage allows any water droplets to flow down to the distillate leg.

Exact heights will have to take into account the annual regime of atmospheric pressures and tide levels.

The requirement to leave sea lift 90% intact can be met by taking so small a proportion of the gross intake of sea water as to leave the blowdown at levels of temperature tolerable to sea life.

No attempt may be required to remove entrained air as it may be assumed that the pervading level of entrained air will simply pass through.

Possible uses of the distillation system are noted in the following: i) To purify sea water or other non-potable water, even sewage liquids so they can be discharged into rivers, brackish lakes; ii) To lift water moderate amounts by placing the distillate leg at a higher elevation than the intake legs; iii) To refine alcohols or other such liquids; iv) To cool spaces or liquids; v) To allow the reuse of water in preparing fruits and vegetables (for example potato chips); and vi) In concentrating ores from the sea by (a) making a deep sphere below the return leg to allow the ores to fall out by supersaturation, (b) removing the moist ores with a screw, (c) adding at the intake only as much new sea water as the process can accommodate, and (d) passing heat back to the down flow leg.

Note that abundant water could enable the vegetation of all warm arid or semi-arid climates to once again trap atmospheric carbon into trees where it once was. The massive change can be effected in as few as 20 years when considering the rate at which some trees grow (for example basswood). Then the concept of more total management of the environment can be considered.

Since various modifications can be made in my invention as herein above described, it is intended that all matter contained in the accompanying specification shall be interpreted as illustrative only and not in a limiting sense.

1. A distillation system comprising:
an evaporation conduit;
an intake supply conduit in communication between a source of solution and the evaporation conduit at the top end of the intake supply conduit;
an intake return conduit in communication between the evaporation conduit at a top end of the intake return conduit and a return sump;
a condensing conduit;
a transfer system connecting the evaporation conduit and the condensing conduit and which is arranged to transfer distillate vapor from the evaporation conduit to the condensing conduit to condense the distillate vapor in the condensing conduit;
a distillate conduit in communication with the condensing conduit so as to be arranged to collect condensed distillate therein;
a vacuum pump connected to at least one of the evaporation conduit and the condensing conduit so as to be arranged to evacuate air from the evaporation and condensing conduits;
a heat exchanger passage in heat exchanging relationship with the distillate conduit so as to be arranged to produce a heated flow of fluid therein; and
a turbine in communication with the heat exchanger passage so as to be arranged to extract usable power from the heated flow of fluid in the heat exchanger passage.

2. The distillation system according to claim 1 wherein the heat exchanger passage comprises an upright passage arranged to direct the heated flow of fluid upwardly therethrough.

3. The distillation system according to claim 2 wherein the distillate conduit extends downwardly from the condensing conduit such that the distillate conduit and the heat exchanger passage are arranged in a counter-flow configuration relative to one another.

4. The distillation system according to claim 1 wherein the heat exchanger passage and the distillate conduit are in a direct heat exchanging relationship with one another.

5. The distillation system according to claim 1 wherein the heat exchanger passage fully surrounds the distillate conduit.

6. The distillation system according to claim 1 further comprising a uniform body of heat exchanging material in which the distillate conduit comprises at least one distillate passage extending longitudinally through the uniform body and in which the heat exchanger passage is in heat exchanging relationship with the uniform body.

7. The distillation system according to claim 6 wherein the heat exchanger passage surrounds the uniform body along a full length of said at least one distillate passage through the uniform body.

8. The distillation system according to claim 6 wherein said at least one distillate passage comprises a plurality of distillate passages extending longitudinally through the uniform body in a parallel and spaced apart relationship relative to one another.

9. The distillation system according to claim 6 wherein the heat exchanging material of the uniform body comprises aluminum.

10. The distillation system according to claim 1 further comprising a grid of aluminum supported in the condensing conduit at a head of the distillate conduit upon which the distillate is arranged to be condensed.

11. The distillation system according to claim 1 wherein a bottom wall of the condensing conduit is slope downwardly in a flow direction from the transfer system to the distillate conduit.

12. The distillation system according to claim 1 in combination with a greenhouse, wherein the turbine is arranged to be exhausted into the greenhouse.

13. The distillation system according to claim 1 wherein the transfer system comprises a pump rotor having a first side in communication with the evaporation conduit, a second side in communication with the condensing conduit, and at least one port communicating between an inlet opening at the first side and an outlet opening at the second side, the pump rotor being supported for rotation about a central axis, said at least one port being oriented with increasing radial distance from the central axis from the inlet opening to the outlet opening so as to be arranged to transfer fluid from the first side to the second side under centrifugal force when rotated.

14. The distillation system according to claim 13 wherein said at least one port comprises a plurality of ports at circumferentially spaced apart locations about the central axis of the rotor.

15. The distillation system according to claim 13 further comprising a transfer tube rotatably supporting the pump rotor therein such that the central axis of the pump rotor is substantially concentric with the transfer tube and such that the transfer tube defines at least a portion of the evaporation conduit and at least a portion of the condensing conduit on opposing sides of the pump rotor.

16. The distillation system according to claim 15 wherein the transfer system further comprises an electric motor having a stator portion supported about the transfer tube and a rotor portion integrally supported on the pump rotor for rotation therewith relative to the transfer tube.

17. A distillation system comprising:
an evaporation conduit;
an intake supply conduit in communication between a source of solution and the evaporation conduit at the top end of the intake supply conduit;
an intake return conduit in communication between the evaporation conduit at a top end of the intake return conduit and a return sump;
a condensing conduit;
a transfer system connecting the evaporation conduit and the condensing conduit and which is arranged to transfer distillate vapor from the evaporation conduit to the condensing conduit to condense the distillate vapor in the condensing conduit;
a distillate conduit in communication with the condensing conduit so as to be arranged to collect condensed distillate therein; and
a vacuum pump connected to at least one of the evaporation conduit and the condensing conduit so as to be arranged to evacuate air from the evaporation and condensing conduits;
the transfer system further comprising a pump rotor having a first side in communication with, the evaporation conduit, a second side in communication with the condensing conduit, and at least one port communicating between an inlet opening at the first side and an outlet opening at the second side;
the pump rotor being supported for rotation about a central axis; and
said at least one port being oriented with increasing radial distance from the central axis from the inlet opening to the outlet opening so as to be arranged to transfer fluid from the first side to the second side under centrifugal force when rotated.

18. The distillation system according to claim 17 wherein said at least one port comprises a plurality of ports at circumferentially spaced apart locations about the central axis of the rotor.

19. The distillation system according to claim 17 further comprising a transfer tube rotatably supporting the pump rotor therein such that the central axis of the pump rotor is substantially concentric with the transfer tube and such that the transfer tube defines at least a portion of the evaporation conduit and at least a portion of the condensing conduit on opposing sides of the pump rotor.

20. The distillation system according to claim 19 wherein the transfer system further comprises an electric motor having a stator portion supported about the transfer tube and a rotor portion integrally supported on the pump rotor for rotation therewith relative to the transfer tube.
